(19) United States
(12) Patent Application Publication
(10) Pub. No.: US 2014/0165098 A1
(43) Pub. Date: Jun. 12, 2014

(54) INSTANT WIRELESS TOUCH SCREEN CONTROL SYSTEM FOR TELEVISION

(71) Applicant: SOUNDWIN NETWORK INC., HSINCHU COUNTY (TW)

(72) Inventors: HETENG HSU, HSINCHU COUNTY (TW); SHI-MING CHEN, HSINCHU COUNTY (TW)

(73) Assignee: SOUNDWIN NETWORK INC., HSINCHU COUNTY (TW)

(21) Appl. No.: 13/794,696

(22) Filed: Mar. 11, 2013

(30) Foreign Application Priority Data
Dec. 12, 2012 (TW) 101224068

(51) Int. Cl. H04N 21/422

(52) U.S. Cl. CPC H04N 21/4222
USPC 725/37

(57) ABSTRACT

An instant wireless touch screen control system for a smart television includes a smart set-top box, a wireless router and a wireless touch screen device. The smart set-top box is electrically connected to the router and the television to fetch an image displayed on the television, and further wirelessly transmits to the wireless touch screen device through the router. The wireless touch screen device transforms the received image from the router into a touch screen image based on some specific algorithm. The user can select and touch one of the icons or items in the touch screen image to generate a touch control signal, transmitted to the smart set-top box through the router. The smart set-top box generates and transfers an image control signal based on the touch control signal to the television, which displays the selected item and performs the preset function corresponding to the image control signal.

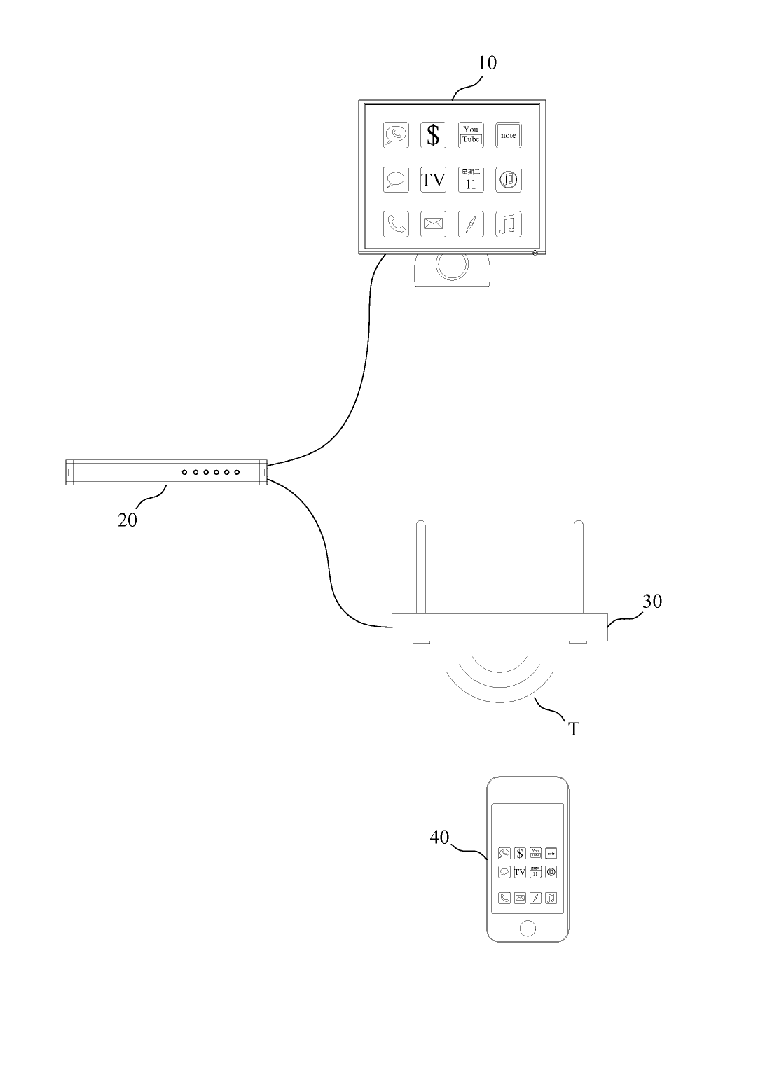

### CROSS-REFERENCES TO RELATED APPLICATIONS

This application claims the priority of Taiwanese Utility Model application No. 101224068, filed on Dec. 12, 2012, which is incorporated herewith by reference.

### BACKGROUND OF THE INVENTION

1. Field of the Invention

The present invention relates to a control system for a television, and more specifically to an instant wireless touch screen control system for a smart television.

2. The Prior Arts

As the modern television sets provide multiple functions and the program manufactures constantly supply various services, the user can easily and directly choose one of the selectable items shown on the television sets to enhance the effect of entertainment in addition to watching the TV programs. For example, the user can play video games so as to achieve entertainment and amusement effects. Especially, the set-top box can provide the user to perform Video On Demand or on-line shopping, or to browse the webs.

For smart televisions in the prior arts, the selectable items are often hierarchically configured. That is, a root or main image having several primary selectable items is first shown, and other selectable items linked to the corresponding primary selectable item selected are then expanded and popped up. In general, a remote control provides keys for the user to pick off one selectable item at one time and the user has to perform the process many times to select all the selectable items as desired. Therefore, the selecting process is complicated and it is not convenient for the common users to correctly operate the remote control. In particular, each system manufacturer may have different and specific hierarchical configuration for the selectable items such that the selecting process is much less user-friendly and hard to learn.

Therefore, it is greatly needed for an instant wireless touch screen control system for a television to implement wirelessly selecting and remote-controlling the smart television by use of a wireless touch screen device provided with wireless remote-control and touch screen functions, which is further enhanced by a smart set-top box and a wireless router, thereby solving the above problems encountered in the prior arts.

### SUMMARY OF THE INVENTION

A primary objective of the present invention is to provide an instant wireless touch screen control system for a smart television, which includes a smart set-top box, a wireless router and a wireless touch screen device. The smart set-top box is electrically connected to the wireless router and the smart television to fetch an image displayed on the smart television. The image is transformed into a wireless signal, which is transmitted to the wireless touch screen device. The wireless touch screen device transforms the wireless signal into a touch screen image based on some specific algorithm to display on the touch screen of the wireless touch screen device. The user can select and touch one of the icons or items in the touch screen image such that the wireless touch screen device generates a touch control signal, which is transmitted to the smart set-top box through the wireless router. The smart set-top box generates and transfers an image control signal based on the touch control signal to the smart television, which displays the selected item and performs the preset corresponding function.

The wireless touch screen device can be implemented by a wireless controller, a touch screen mobile phone or a touch screen tablet with a touch screen function. Therefore, it is possible to wirelessly select and control the smart television through the wireless touch screen device.

### BRIEF DESCRIPTION OF THE DRAWINGS

The present invention can be understood in more detail by reading the subsequent detailed description in conjunction with the examples and references made to the accompanying drawings, wherein:

FIGURE is a schematic view showing an instant wireless touch screen control system for a television according to the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only one preferred embodiment of the invention and shall not be considered as limitations to the scope of the present invention. Modifications of the shape of the present invention shall too be considered to be within the spirit of the present invention.

FIGURE illustrates an instant wireless touch screen control system for a smart television according to the present invention. As shown in FIGURE, the instant wireless touch screen control system of the present invention generally includes a smart television 10, a smart set-top box 20, a wireless router 30 and a wireless touch screen device 40 to implement the functions of wirelessly controlling the smart television 10 and instantly choosing the selectable items.

The smart television 10 provides and displays several selectable items or icons in an image such that the user can perform the selecting process to select at least one item or icon and invoke the preset function corresponding to the selected item or icon, such as selecting the television channel, invoking Video On Demand, playing video games, going on-line shopping, browsing the webs, transmitting/receiving the email, or performing remote surveillance.

The smart set-top box 20 is electrically connected to the smart television 10 to fetch and transmit the image displayed on the smart television 10 to the wireless router 30. The wireless router 30 is electrically connected to the smart set-top box 20, and transforms the received image from the smart set-top box 20 into a wireless signal T, which is wirelessly transmitted to the wireless touch screen device 40. More specifically, the wireless touch screen device 40 provides a function of touch screen, and can be implemented by a wireless controller, a touch screen mobile phone or a touch screen tablet. The wireless touch screen device 40 receives the wireless signal T from the wireless router 30 and transforms the wireless signal T into a touch screen image based on some specific algorithm, which is to be displayed on the wireless touch screen device 40.

The user can employ the wireless touch screen device 40 to select the items or icons by touching and generating a touch screen control signal, which is wirelessly transmitted to the wireless router 30. The wireless router 30 further transmits the received touch screen control signal to the smart set-top box 20, which generates an image control signal according to the touch screen control signal. At the same time, the image control signal is transferred to the smart television 10 such that the smart television 10 instantly displays the selected items based on the received image control signal, and executes the preset function corresponding to the selected items.

In another preferred embodiment of the present invention, a smart wireless set-top box (not shown) is used instead of the smart set-top box 20 and the wireless router 30. Alternatively, it is possible to combine the smart set-top box 20 and the wireless router 30 to form the smart wireless set-top box. That is, the original functions of the smart set-top box 20 and the wireless router 30 are provided by the smart wireless set-top box.

Therefore, one of the aspects of the present invention is to provide a more user-friendly operation to select and invoke the preferred items on the smart television. More specifically, the user can use the wireless touch screen device to select the items or icons provided by the smart television, and then the smart television instantly performs the corresponding preset functions so as to implement the remote select operation for the smart television. It is apparent from the above-mentioned that the present invention provides the wireless touch screen device to replace the traditional wireless remote control with specific function keys, thereby easily and fully exploiting the versatile and complicated functions of the modern smart television. Especially, the user can directly operate the wireless touch screen device by vision and touching, and the operation process is thus improved and becomes simple such that the learning curve is shortened and the industrial applicability is greatly enhanced.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An instant wireless touch screen control system for a television, comprising:
a smart set-top box electrically connected to a smart television displaying an image having a plurality of icons or items which are selectable by touch, wherein the smart set-top box fetches and transmits the image;
a wireless router electrically connected to the smart set-top box to receive the image, transforming the received image into a wireless signal, and wirelessly transmitting the wireless signal; and
a wireless touch screen device having a touch screen provided with a wireless communication function, wherein the wireless touch screen device wirelessly receives the wireless signal from the wireless router, and transforms the wireless signal into a touch screen image based on a specific algorithm, which is displayed on the touch screen,
wherein at least one of the icons or items in the touch screen image displayed by the wireless touch screen device is selected and touched by a user such that the wireless touch screen device generates a touch control signal which is wirelessly transmitted to the wireless router, the wireless router further transfers the touch control signal to the smart set-top box such that the smart set-top box generates and transfers a control signal based on the touch control signal, and the smart television receives the control signal and then instantly displays and executes a predetermined function corresponding to the at least one of the icons or items selected by the user based on the control signal.

2. The instant wireless touch screen control system as claimed in claim 1, wherein the wireless touch screen device includes a wireless controller, a touch screen mobile phone or a touch screen tablet with a touch screen function.

3. The instant wireless touch screen control system as claimed in claim 1, wherein the smart set-top box and the wireless router are combined to form a smart wireless set-top box.
